(19) United States
(12) Patent Application Publication
(10) Pub. No.: US 2001/0031451 A1
(43) Pub. Date: Oct. 18, 2001

(54) Method for interactively monitoring and changing the behavior, attitude or educational state of an individual, in particular an individual related to an organization

(76) Inventors: Soren Sander, Frederiksberg C (DK); Jens Byriel, Copenhagen K (DK); Kenneth B. Hayes, Toluca Lake, CA (US); Erik W. Vinke, Kastrup (DK); Peter Aaro-Hansen, Frederiksberg (DK)

Correspondence Address: BIRCH STEWART KOLASCH & BIRCH, PO BOX 747, FALLS CHURCH, VA, 22040-0747, US

(21) Appl. No.: 09/801,650

(22) Filed: Mar. 9, 2001

Related U.S. Application Data
(60) Provisional application No. 60/195,046, filed on Apr. 6, 2000.

(30) Foreign Application Priority Data
Mar. 10, 2000 (PA) 2000 00396

(51) Int. Cl. G09B 19/00

(52) U.S. Cl. 434/236

(57) ABSTRACT

The present invention is a method and a system for interactively monitoring the behavior, attitude and educational state of individuals of an organization, especially in relation to ergonomically reasonable conduct of the individuals. The method and system provides an index representative of the behavior, attitude and educational state. The index is provided by monitoring ergonomically relevant conditions of the individual's working surroundings and the individual's use of PCs or similar computers connected to the system and by means of information obtained by subjecting the individual to electronic questionnaires. The monitored data and data obtained by electronic questionnaires will be compared with reference data for providing instructions for the individual.

The present invention relates to an education and evaluation method useful in particular for aligning individual behaviors with organization goals. More specifically the invention relates to the technical problem of monitoring individuals of an organization by the use of a combination between electronic indicators encapsulated in the individuals working environment and from electronically provided and supported questionnaires. Further the invention relates to the establishment of indexes indicative of the behavior, attitude or educational state(s) of the individual, from the monitored data.

The method uses a computer system to interactively monitor and to optionally change the behavior and/or attitude and/or educational state of an individual. The method can be used for changing the individual's state by using training, testing and feedback and comparing the results against the individual's starting condition, other individuals and/or goals set by the individual's organization. The computer-based method can be delivered over an on-line network (e.g. Internet or Intranet).

The method uses a unique combination of training and evaluation focused on the individual user, optionally combined with the collective focus on goals and measurements for a group of individuals as part of an organization. Also unique is the ability to measure, express and account for a combination of an individual's behavior, attitude, educational state, physical state and/or environment.

The system is described in the context of an embodiment for ergonomic training to prevent and alleviate injuries due to the incorrect or prolonged use of computer equipment. However, it may be readily adapted for other areas The method remains the same, and merely the training content and measurement definitions must be adapted to other subjects.

The present invention relates to the field of on-line, computer-based education and behavior modification, and in particular to a method and system of computer-based diagnosis, training and evaluation of an individual's behavior relative to their environment, organization, and other individuals and influencing their well-being, and/or health and/or performance.

### BACKGROUND

As the use of computers has increased dramatically in our society, new working patterns have emerged and new devices (e.g. computer screens, keyboards and mice) are being used now by a majority of the population. Though the economic and intellectual benefits have been great, some of the more negative effects have been an increasing prevalence of injuries due to improper use or extended use of computers and related new devices. These negative effects are, for example, RSI (Repetitive Stress Injury), CTD (Cumulative Trauma Disorders), backaches, headaches, eye strain, etc.

The field of ergonomics, the study of the body's muscular-skeletal system, has developed commonly available guidelines for improving the well-being of people using computers. These include adjusting the user's sitting position, adjusting the position of the computer screen or mouse, taking frequent breaks from repetitive work, etc. Yet these guidelines are only effective to the extent that users have the proper equipment available, are motivated to improve their situation and trained to do it correctly.

Within the last 10 years, an industry of ergonomic consultants (typically physical therapists) has grown to service the needs of users who have been injured due to using computers. The therapists meet personally with individuals either at the workplace or in classes. This is a very time-intensive task and only a small number of people can be treated per day. Thus, while the personal instruction form is effective, it is an expensive solution, and available only to a minority of computer users.

Less-expensive forms of information and training, such as pamphlets, books or video programs, may describe the correct behaviors, but they have been demonstrated to have a low interest level for users, as they lack the stimulation and feedback available with personal training. These forms are passive, in that they cannot react nor adjust their advice based on a user's individual situation. There is no on-going alert mechanism to remind the user to adjust their behavior. In addition, these forms have no built-in method to verify that an individual has actually implemented the guidelines correctly. Thus, while the traditional written/video forms of instruction are broadly available, they are not very effective.

Alternative forms of prevention and treatment include physical devices, such as specially-designed chairs, computer mice, computer keyboards, adjustable tables, etc. Common for all these solutions is that once they are installed, there is no built-in monitoring of the user to verify that the user's welfare has been improved. No device alone will necessarily improve an individual's well-being, and it may in fact compound the problems if used incorrectly. A user with a sore back may not necessarily need a height-adjustable table, but rather may just need to adjust their chair correctly and/or perform certain exercises.

Organizations with individuals (e.g. companies with office employees) who use computers, are faced with additional challenges. Discomforts and injuries due to computer use result in lower productivity and work absence, which negatively affects an organization's profitability. Organizations risk being held liable for workers' compensation if their employees develop injuries which could have been prevented. Organizations also have to determine which groups of employees are most at risk for injuries. Organizations must also determine which forms of training and investment are relevant to maintain the well-being of their employees. This information is not readily accessible unless a thorough audit of the organization's activities is undertaken, which is both time-consuming and expensive. In addition, goals of individuals might not match the goals of their organization, resulting in sub-optimal use of resources. For example, an employee may demand a new expensive multi-adjustable chair, when in fact training in correct use of their existing chair will alleviate their problem.

Therefore, the prevention and alleviation of computer-related injuries is both an important area to address as well as an area where there is no obvious nor cost-effective solution which can reach a large number of the users at risk.

E-learning, traditionally known as computer-based training, has the potential to address the deficiencies mentioned above. Recent developments in multimedia techniques can provide a learning experience for users which is engaging, highly motivating and results in higher retention rates than traditional media such as pamphlets, books and videos.

E-learning also enables personalization so that each individual user can receive training based on their personal situation.

Networks (such as the Internet), combined with personal computers, enable broad access to Information, regardless of geographic or time factors. Networks also enable the collection of data from many individuals and aggregation of that data on both an organizational and global level.

A recent patent (U.S. Pat. No. 5,813,863 issued to Sloane et. al. on Sep. 29, 1998) describes a computer-based education system for behavior modification which accounts for user-supplied feedback but does not apply this to the context of the individual's physical state or organization,

Another recent patent (U.S. Pat. No. 5,879,163 issued to Brown, et. al on Mar. 9, 1999) also describes a computer system for health-related education and behavioral change which accounts for an individual's own motivation for education, but it does not apply this to the context of an individual's organization.

In view of the above, the purpose of the present invention is to provide a computer-based method which can accurately analyze an individual's present behavior, attitude, and/or educational state, then provides training to improve, e.g., their well-being, health and/or performance which is relevant both for them personally and for their organization, and then verifies that they have changed their behavior, attitude and/or educational state.

A further purpose is to enable an organization to set goals for various parameters for the individual to achieve, in order to align individual goals with the organization's goals.

Another purpose is to sample parameters related to the individual's activities within their organization, their attitude, physical and/or education state and their environment and build this up into a database, in order to create a body of data which can be used for research.

After subjecting the individual to training, and re-evaluating the parameters mentioned above, the method creates at least one measurement index which can be used to compare the individuals against, e.g., their prior state, their colleagues within an organization or similar individuals on a global basis. The purpose is to subject the individual to additional relevant training or recognize when a goal has been met. Summary data for organizations also can be compared in order to provide valuable information to administrators, management and/or researchers.

The overall advantage of the method is that an individual's behavior and/or well-being and/or performance can be aligned with their organization's goals, and these can be compared to other individuals and organizations on a global basis. When applied to an ergonomic field of computer-related injuries, as an example, it should reduce the incidence of injury and shorten the healing time while at the same time enable an organization to optimize its investment and efforts.

### DISCLOSURE OF THE INVENTION

The invention relates to a method for interactively monitoring and optionally changing the behavior state(s) and/or attitude state(s) and/or educational state(s) of an individual, comprising

storing, in a database of a computer system,

a reference measure with respect to the behavior state(s) and/or attitude state(s) and/or educational state(s), the reference measure quantifying characteristics relating to the same state(s),

subjecting the individual to a series A of information and/or training routines and/or questions relevant to the said state(s), and recording at least one set of parameters P1 established as a result of the series A and related to the individual or activities of the individual and indicative of the said state(s), and storing the result of the recording in a database of the computer system,

processing the set(s) of parameters P1 to provide at least one index representing the status of the individual with respect to the said state(s),

comparing the at least one index with the reference measure,

and, based on the result of the comparison,

a) classifying the individual, and/or

b) subjecting the individual to further questions and/or information and/or training routines of either series A or another series.

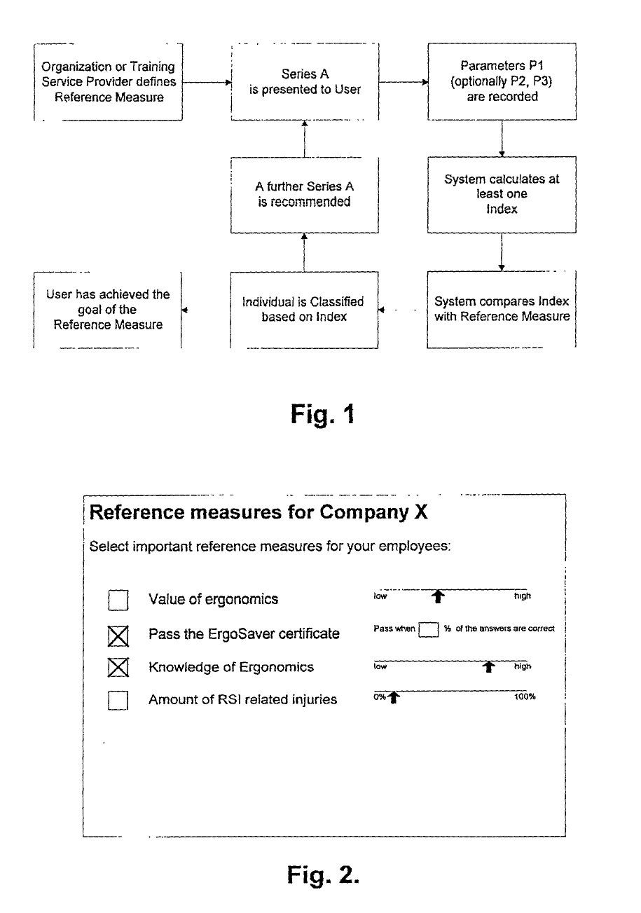

The flow diagram, see FIG. 1, shows the process of the method in a general form.

The method requires a reference measure of an individual's behavior and/or attitude and/or educational state to be defined and stored in a database. The reference measure may or may not consist of parameters representing directly measurable characteristics, but at any rate, the reference measure must be able to quantitatively express the state of an individual by means of a parameter or parameters which can be compared with directly measured or modified or derived quantitative parameters established by monitoring the individual. Thus, e.g., the reference measure can express a goal (a desired end condition) set for the individual with respect to the result of training to be performed, or an average of individuals related to an organization, or an average of individuals of a particular age group, or an average of a particular professional group, or an average of individuals of several organizations or of individuals of the society in question. The reference measure can also express a starting condition of the individual, although, as explained in the following, it is often preferred to include the starting condition of an individual as a separate set of characteristics, distinct from the reference measure.

The series A of information and/or training routines and/or questions to which the individual is subjected comprises information and/or routines and/or questions which are relevant to the said state or states, which means that the information and/or routines and/or questions are adapted to provide information (parameters P1) about the present state or states of the individual, or to influence, educate, motivate or train the individual so as to change the state(s) in a desired direction, in which latter case the information and/or routines and/or questions also comprise such information and/or routines and/or questions which serve to obtain information (parameters P1) about to what extent the state(s) are changed. Series A may be expressed as textual, graphic, audio or visual data, or a combination, such as with animations.

The parameters P1 are stored in a database of the computer system, normally for as long a period as is relevant with respect to the particular individual, that is, e.g., as long as the individual is related to the organization, or at least until the parameters P1 have been processed to provide the at least one index representing the status of the individual with respect to the state(s) mentioned. The database may be an advanced database of any kind, such as a relational database, or it may simply be a file or table in a storage or memory of the computer system or connectable to the computer system, e.g. through a network.

The index representing the status of the individual may be provided in many ways, examples of which are given in the following. It is important, however, that the index is a quantitative index which can be compared, by means of the computer system, in a meaningful way with the quantitative characteristics of the reference measure.

Thus, the comparison of the at least one index with the reference measure will normally be a quantitative comparison resulting in a quantified relationship, such as percentage or a fraction, between the reference measure and the index.

Based on the comparison, the individual may be classified; for example, the individual may be categorized in predetermined categories dependent on the quantitative relationship between the index and the reference measure.

It may be desired to subject the individual to further questions and/or information and/or training routines of either the same series A or of another series. Such series may, e.g., be selected based on the recorded values of the parameters P1 and/or on the basis of the index or indices or the classification. In connection with such further questions and/or information and/or training routines, parameters P1 are normally again recorded, and at least one index is normally provided, etc.

According to an important embodiment of the invention, the individual is an individual related to an organization, e.g. an employee of a company, and the reference measure is a reference measure selected by the organization in collaboration with a provider of the method or at least partly defined by that organization, often in collaboration with the provider of the method. The provider of the method will normally be an enterprise who has at least some expertise with respect to the parameters to be monitored. As an example, if the relevant parameters are parameters relating to ergonomics, the provider of the method will normally have access to ergonomics expertise, such as by having ergonomics experts employed. Also other fields of expertise may be possessed by the provider of the method, such as the ability to interpret recorded parameters correctly, which may require psychological expertise, etc.

It is often of importance to store in the database, together with the reference measure, characteristics relating to a starting condition of the individual with respect to the behavior state(s) and/or attitude state(s) and/or educational state(s) and processing the characteristics relating to the starting conditions together with the processing of the set(s) of parameters P1, and/or comparing the set(s) of parameters P1 and/or the index with the starting condition and/or the reference measure and/or the quantification values of the reference measure representing the desired end condition, and, based on the result of the comparison, classifying the individual, and/or subjecting the individual to further questions and/or information and/or training routines of either series A or another series. The inclusion of the characteristics relating to a starting condition of the individual permits assessment of the progress of the individual.

For a number of fields of use, e.g. the ergonomic field, it may be important to include one or more sets of parameters P2 relating to a physical state of the individual in the processing to provide the at least one index. Examples of such parameters are sex, age, weight, fitness rating, blood pressure, heart rate, etc., since these parameters may influence the capability of the individual to adapt and/or perform in connection with the information, training routines and/or questions, and since these parameters may be desired and important constituents in the index or indices to be provided. Correspondingly, it may, for a number of fields, and again for the ergonomic field, be important to include one or more sets of parameters P3 relating to a relevant environment of the individual in the processing to provide the at least one index. Examples of such parameters are characteristics of the room in which the individual works, such as size, temperature, light conditions, etc., characteristics of furniture used by the individual, characteristics of tools and instruments used by the individual, transportation means, noise, and pollution of chemical or microbiological type, etc., since these parameters may influence the health and comfort states of the individual and the ability to adapt or perform, and since, at least to a certain extent, these parameters may be parameters under the control of the organization to which the individual is related.

The sets of parameters P2 and P3 may be pre-stored in a database or a memory or storage of the computer system, typically by the organization and/or by the individual.

Alternatively, the one or more sets of parameters P2 and/or P3 may be recorded as a result of subjecting the individual to the series A, e.g., by manual entry by the individual.

As an interesting possibility, one or more sets of any of the parameters P1 and/or P2 and/or P3 may be recorded by means of one or more measuring devices such as, e.g., temperature sensors, moisture sensors, air pollution sensors, light sensors, weighing devices, body condition sensors (e.g. heart rate monitor), etc Such devices may be devices capable of directly or indirectly communicating with the computer system.

An interesting way of recording one or more sets of parameters P1 and/or P2 and/or P3 is to monitor the individual's use or configuration of a device, such as, e.g., devices selected from the group consisting of telephones, including mobile telephones; personal digital assistants (PDA); fax machines; scanners; dictating machines, cameras, including still cameras and video cameras, microphones; furniture; tools, instruments, production machines, conveyors, sorters, vehicles, medical devices, prosthetics, care utensils, such as wheelchairs and hoists.

In accordance with the above statement about the impact of computer usage on health, most relevant devices in this connection are computers or computer peripherals such as input devices, e.g., a mouse or a keyboard.

The recording of parameters relevant to the individual's use or configuration of a device may be performed at least in part by the individual inputting parameter-relevant data into the computer system, or, where possible, by the device directly or indirectly communicating with the computer system. Important examples of devices that may communicate directly or indirectly with the computer system are of course computers or computer peripherals, but it is also contemplated that it will become important, in connection with the method of the invention, to provide relevant sensing/measuring devices connected to or integrated in a number of ergonomically important devices such as furniture, including tables and chairs where the sensing/measuring devices can communicate the configuration and use thereof directly or indirectly to the computer system.

One of the crucial features of the present invention is the provision of an index which can be compared with the quantified data of the reference measure. Thus, as stated above, the index is normally a quantified index, and a very useful type of index is an index which simply quantifies one or several parameters on a scale from a low number to a high number, as this is a type of indication which is easy to understand and remember by humans and suitable for graphical representation as well as for comparison between individuals, between organizations, etc. In a preferred embodiment, the reference measure — or the part of the reference measure which is to be compared with a particular index — has been quantified in the same manner as the index in question, allowing a direct quantitative comparison, e.g. “is the individual performing better or worse than indicated by the reference measure?”. An index may be determined by accurate measurable objective data, such as number of days lost through sickness over a particular period or an amount paid in sick pay, or an index may be a value indicated by the individual as a response to an invitation to indicate a subjective opinion as a value on a scale.

A particular feature of the present invention is the establishment of complex indices, that is, combinations of values from fields that cannot directly be added or subtracted and which, in combination, define a new field which has a higher information complexity and content than the individual fields. As an example, one field of a complex index may be related to physical well-being of the individual (subjectively stated), and another field may be related to the age and height of the individual (objectively obtainable values), and the combined, more complex field of a complex index may be related to the statistical likelihood that the individual may develop a sore back or back injury. Complex indices may be constructed in many ways, but the most valuable complex indices are, of course, complex indices having a high correlation between the value of the index and the degree or state of the condition related to the more complex field in question. Thus, in the processing of parameters to provide an index, it will be preferred to relate and optionally weigh the individual components of the index in a manner which results in a high degree of correlation between the value of the resulting complex index and the actual condition in a particular complex field. The relationships and weighing between the individual components of the index may suitably be established by functions using combinations of static rules and rules derived from experience, e.g. from historical data. Depending on the type and purpose of the index, not only data pertaining to the parameters P1, P2, P3 may be processed, but also data of, e.g., geographic or climatic or demographic type, obtained from other sources, may be included in the processing to provide complex indices.

The processing of the parameter and optionally additional data to provide a complex index may be performed using suitable methods Well-known functions may be used or adapted to the purpose, such as functions selected from the group consisting of calculation, statistical calculation, stochastic simulation, fuzzy logic rules and adaptive networks, such as neural networks, so as to establish, for a given number of parameters each having a predetermined result space, the result space for combinations of the parameters.

The determination of the result space of at least some of the parameters may be performed based on consolidated data from a number of individuals, such as sum data or average data from a number of individuals.

An interesting possibility is to increase the quality of the method by adjusting the reference measure periodically to take into account an increased quality in prediction based on an increased number of relevant parameter data which have been gathered and optionally additional relevant data, such as statistical data and correlations obtained in other contexts, e.g. reported in the literature or reflecting new scientific observations or hypotheses.

The reference measure will normally have been explicitly input into the database as an initial data, but it is also within the scope of the invention to have a reference measure which is derived from data input, e.g., historical data. In a simple example of this, the reference measure may consist of one or a group of indices, such the latest index or the latest group of indices, or the reference measure may be constructed from one or several indices and/or parameters according to predefined criteria.

Where it is important to compare references measures, parameters or indices between several individuals, groups of individuals, organizations, and even societies, etc., it is, of course, important that any changes in the establishment of reference measures, parameters or indices are performed in parallel and simultaneously for the individuals, groups, organizations or societies, or that differences are compensated for by suitable adjustment factors or algorithms.

In cases where the reference measure or part of the reference measure expresses a desired end status of the individual or, e.g., the average status of a relevant reference group of individuals, the individual may be informed about its progress relative to the desired end status or the average status expressed by the reference measure. The individual may be informed based on the value of one or more of the parameters or based on one or more simple or complex index. Thus, e.g., the individual may be alerted if the set of parameters P1 and/or P2 and/or P3 results in an index which indicates a lower standard than expressed by the reference measure. Such alerting may, in special cases, be given in the form of an interruption of a job routine related to the alerting given.

Another interesting possibility is to enable the individual to enter observations related to a relevant problem in the individual's actual state, such as an illness, a sore back, headache, sleep problems, etc., and obtain suggestions for cause or remedy of the adverse state based on the observation entered in combination with parameters and indices already stored in the database. In this case, relevant indices and relevant parameters are indices and parameters for which a relation to the adverse condition is available directly or derivable from the database, including data for the individual. As an example, if the individual enters observation about a headache on a particular day, it may be possible, by means of parameters stored in the database to combine this fact with, e.g., data indicating that the individual worked stressfully and in a tobacco smoke-filled environment for many hours on the previous day. Evidently, part of the value of this possibility is that it may reveal causal relationships which are difficult to obtain for, e.g., the individual's medical doctor, and/or that complex causal relationships may be revealed by analyses based on relevant complex indices.

While the field of use of ergonomics is an evidently important field in connection with the present invention, it is evident that the method may be of great value also in connection with a number of other fields of life. Thus, e.g., the behavior and/or attitude state relevant to the organization may refer to environmentally reasonable conduct of the individual and the educational state of the individual may refer to the knowledge of the individual with respect to the environmental issues in question, or the behavior and/or attitude state relevant to the organization may refer to economically reasonable conduct of the individual and the educational state of the individual may refer to the knowledge of the individual with respect to the economical issues in question, or the behavior and/or attitude state relevant to the organization may refers to socially reasonable conduct of the individual and the educational state of the individual may refer to the knowledge of the individual with respect to the social issues in question. It is also possible to combine two or more of the above fields with each other or with other fields, etc. etc., resulting in highly complex indices which could make it possible explore highly complex relationships and correspondingly improve performance, quality of life, etc. of individuals or groups of individuals or improve the performance or quality of organizations or societies. In this connection the outstanding possibilities, discussed below, of comparisons based on the essential features of the method of the invention, may be of great value.

Examples of Important types of indices in connection with the above-discussed fields are one or more of the following:

health index

attitude index

knowledge index

behavior index

performance index

physical environment index

risk index.

The establishment of most of the above indices is discussed above. The risk index will normally be designed to quantitatively reflect the probability of future changes of the other indices.

An often suitable and easily understandable way of representing an index is to represent the index graphically by means of the interface in which

the index is represented as a function of the reference measure and/or

the index is represented as a function of one of the sets of parameters P1 and P2 and P3.

An important utilization of the method of the invention is to establish predictions or forecasts which can give valuable information about a probable development during a defined future period. These predictions or forecasts can relate to the individual, or to the organization, or to the relation between the individual and the organization, or to the relation between organizations, or the society, all depending on which data are incorporated in the prediction or forecast. Thus, this embodiment of the invention comprises further processing at least one of the indices or at least one of the parameters P1, P2 and P3 by processing means using a simulation algorithm for forecasting data relevant to the organization or the individual. Simulation algorithms useful for this purpose are well-known in the art. One advantage of this embodiment of the invention is that a complex index found to have or proved to have a relevant information value may be used as the basis for a prediction or forecast, and that such a complex index established in one and the same manner for several individuals and/or organizations may be used for standardized and generally acceptable comparisons between individuals and/or organizations and/or societies.

The computer system used in the method according to the invention may be any computer system comprising the appropriate processor means, memory means, storage means and input-output means. It is normally preferred that the computer system is a computer system which communicates through a network with a computer at the site of the individual and optionally with at least one more computer and normally several other computers, thereby establishing a true network capable of serving, e.g., the needs of an organization (where normally both connection to computers at the sites of the individuals and access to computers of other organizations through a direct or indirect network are necessary).

One of the advantages of the method of the invention is that it provides unique possibilities for defining groups or one or more individuals according to relevant and partly hitherto unavailable criteria. Thus, one or more sets of data each containing at least one of the following types of data

reference measure,

series A,

set of parameters P1,

set of parameters P2,

set of parameters P3,

at least one index and/or

forecast data relevant to the organization or the individual,

may be used for defining groups of one or more individuals by defining the groups as comprising individuals' data for whom are within predetermined value ranges within the particular type of data. Data for the individual groups thus defined may then be compared or analyzed. The data for individual groups which are compared are data will normally be data which are not identical to the sets of data according to which the groups were defined. The data which is compared or analyzed will often be data pertaining to the types of data defined above, by it may also be different types of data, such as, e.g., geographic or demographic data.

Because of the high relevance of the data resulting from the method of the invention, such as the types of data discussed immediately above, it may be most valuable to compare or analyze the development over time of data values for individuals within individual groups.

Data selected from the group consisting of

reference measure,

series A,

set of parameters P1,

set of parameters P2,

set of parameters P3,

at least one index and/or

forecast data relevant to the organization or the individual,

may be used or processed to obtain methodical and/or statistical surveillance/observation or analysis of a group of one or more individuals or a group of one or more organizations. The data may be accumulated over a period of time, and the accumulated data may be used or processed. The methodical and/or statistical surveillance/observation or analysis of the group may be particularly valuable for discovering or reveal desired or undesired developments at an early stage of such developments

In another interesting field of use, data selected from the group consisting of

reference measure,

series A,

set of parameters P1,

set of parameters P2,

set of parameters P3,

at least one index and/or

forecast data relevant to the organization or the individual

may be defined for a group of one or more individuals and may be compared to the same data of another group of one or more individuals, such other group being defined based on respective other data of the above-mentioned types, or being based on criteria which are outside the above-mentioned group of data, e.g., geographic or demographic data.

An interesting comparison rendered possible through the present invention is that at least one of the following types of data:

reference measure,

series A,

set of parameters P1,

set of parameters P2,

set of parameters P3,

at least one index and/or

forecast data relevant to the organization or the individual,

may be compared between one individual and at least one other individual of the organization or of another organization. As an example, an individual can see that he/she has a higher incidence of injury than other employees in similar positions in other companies.

Another interesting possibility is that at least one of the following types of data:

reference measure,

series A,

set of parameters P1,

set of parameters P2,

set of parameters P3,

at least one index and/or

forecast data relevant to the organization or the individual,

may be compared between the organization and at least one other organization. As an example, a telephone call-center company with many employees who use computers all day can see that compared other similar companies who use this system, they have a higher incidence of eye strain among their employees, and they thus may decide to invest in better e.g. glasses/lamps/screens for their employees.

At least one of the following types of data:

reference measure,

series A.

set of parameters P1,

set of parameters P2,

set of parameters P3,

at least one index and/or

forecast data relevant to the organization or the individual,

may be compared between the individual and at least one organization. As an example, employees can see if they have a worse rate of injury compared to their similar colleagues, and thus better understand why it is important to follow the advice of a an ergonomics version of the method according to the present invention.

According to another aspect, the present invention relates to a computer system for interactively monitoring and optionally changing the behavior state(s) and/or attitude state(s) and/or educational state(s) of an individual, said computer system having first processing means, input means for user provided input, output means and first storage means having stored therein a first computer program said processing means being adapted, in response to commands from said computer program, to perform the above described method.

The processing means may preferably be adapted, in response to commands from said computer program, to interactively monitor and optionally change the behavior state(s) and/or attitude state(s) and/or educational state(s) of an individual over a computer being used by the individual, the computer being connected to the computer system and cooperating herewith. The computer could as an example be connected to the computer system over a regular LAN connection, a phone line connection, over the Internet etc. The computer could as an example be the computer of the individuals regular working environment. For an office employee the computer could be the regular PC being a typical part of most offices and for worker in a factory, the computer could be comprised e.g. in a machine such as in an numerically controlled mill, a robot, a lathe etc. Such NC or CNC machines are typically operated by a wide variety of operating systems and it is therefore preferred that the cooperation between the computer system and the computer is independent on the operating system of the computer system respectively the operating system of the computer. It would be preferred that the computer at least has means for user interaction, e.g. a screen and a keyboard. It is further preferred but not essential that the computer has its own second processing means and its own second storage means having stored therein a second computer program. The second processing means should be adapted, in response to commands from the second computer program, to monitor the users behavior with respect to the users use of the computer. The monitored behavior data may be stored in a file and communicated to the computer system or the monitored data may be transferred continuously to the computer system.

Since the user of the computer - the individual being monitored - may not always be capable of operating advanced computer programs and systems, the second program is preferably automatically initiated by second processing means upon activation of the computer, e.g. when the computer is turned on. The program could then be running in the background throughout the working day for the monitoring of the individual during the daily working routines and work with the computer.

The monitored behavior data may either by the first and/or by the second processing means be compared with reference data for the behavior of the specific individual or with reference data for individuals of a specific group. As an example, it may be monitored how many percent of the day the individual uses the keyboard and/or the mouse of the computer. The monitored data may be compared with an average value for the use of computers or be compared with an average value for the specific individuals regular use of the computer. If it turns out that the individual has been using the mouse more frequently than either recommended or usual, the computer may provide an indication to the user on having a break, doing some exercises etc.

Preferably the computer is operated by the Windows™ operating system. In that case the second processing means may be adapted to monitor the behavior of the user by monitoring a Windows™ messaging queue of the Windows™ operating system. The queue may either be communicated to the computer system and monitored by the first processing means or be monitored directly from the computer by the second processing means.

Preferably either the first or the second processing means may be adapted to provide an index representing the behavior of the user, e.g. a number on a scale representing average of a society, an organization or the individual. The index can then be compared with reference indexes.

The second processing means may be adapted, in response to commands from the second computer program, to generate user instructions based on the comparison of the index with a reference index and the user instructions being provided to the user via the means for user interaction. As an example, the user may be instructed to go through educational sessions, to stop using the mouse, to adjust the height of the screen or chair etc. These instructions could be based on the comparison between the index of the user and reference indexes.

The computer could be connected to sensor means for determining a first electrical signal indicative of a physiologic factor of the individual and for transferring the first electrical signal to the second processing means. As an example, the mouse buttons of the computer mouse could be adapted to measure the temperature or the pulse of the user, or the user could have an wristband capable of measuring blood pressure, pulse and/or temperature and to transmit the measured data to the computer. Other sensors may also be applied, e.g. sensors capable of determining a second electric signal indicative of ergonomically relevant conditions of the individual's working surroundings and for transferring the second electrical signal to the second processing means. Examples are sensors for registering the settings of a chair (height, bag position etc.), sensors for registering the light intensity of the office, the height of the tables, the angle and height of the computer screen, the temperature and/or humidity of the office etc. The sensor means for determining the first electrical signal or the sensor means for determining the second electrical signal may be comprised in regular computer peripheral device, e.g. comprised in the mouse as before mentioned or be comprised in the screen. As an example stress may be detected by the speed the mouse is used with or by the impact the keys of the keyboard punched.

According to a preferred embodiment of the invention, a user profile is stored in the first storing means or in the second storing means. The second program is then configured by the first processing means and the second processing means, the configuration being based on the user profile. As an example, the user profile contains information related to the physiologic or psychological state of the user of a computer, e.g. information about a back problem, headaches etc. The profile is used by the second program and the second processing means in order to monitor events which are important for that specific user. As an example, headache could relate to stress and therefore the speed and impact the keys of the keyboard is being punched, is being monitored. Back problems could on the other hand lead to monitoring of the frequency of the use of the computer mouse.

The user profile could as an example be generated based on a pre-test program with a questionnaire for the user.

It may be an advantage to implement the aforementioned technical features in a graphical platform so as to enhance the user-system interaction. To do so it will be an advantage to use tools such as ActiveX or JAVA applications since they may be executed locally on the computer. provided with data e.g. from the first storage means. The advantage thereby being an enhanced capacity and capability of the computer system - especially when connected to many computers.

### DETAILED DESCRIPTION OF THE INVENTION

A preferred embodiment of the invention will now be described in details with reference to the drawings in which:

FIG. 1 shows the process of the method according to the invention in a general form

FIG. 2 shows an input screen for selection of reference measures important for a company,

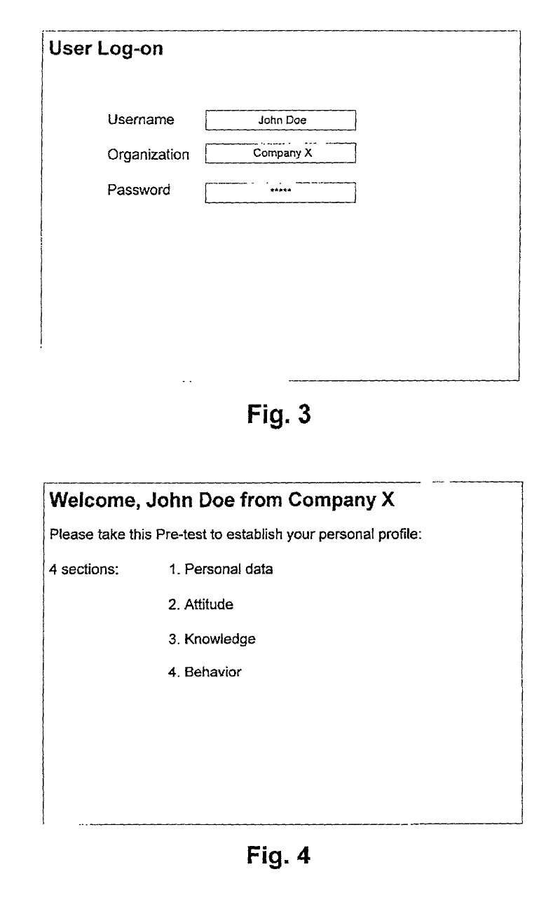

FIG. 3 shows a user log-on screen,

FIG. 4 shows a user interface screen of the pre-test,

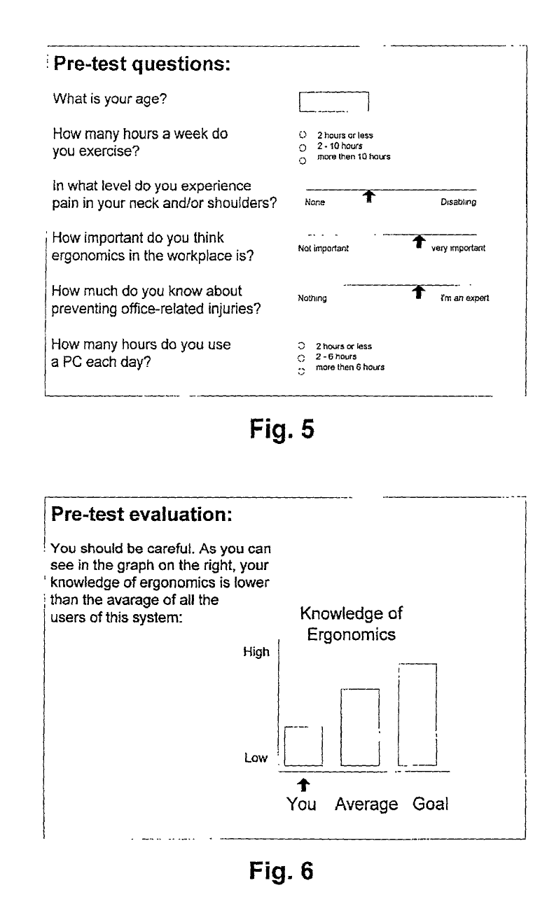

FIG. 5 shows another user interface screen of the pre-test,

FIG. 6 shows a user interface screen for presentation of the index generated based on the pre-test,

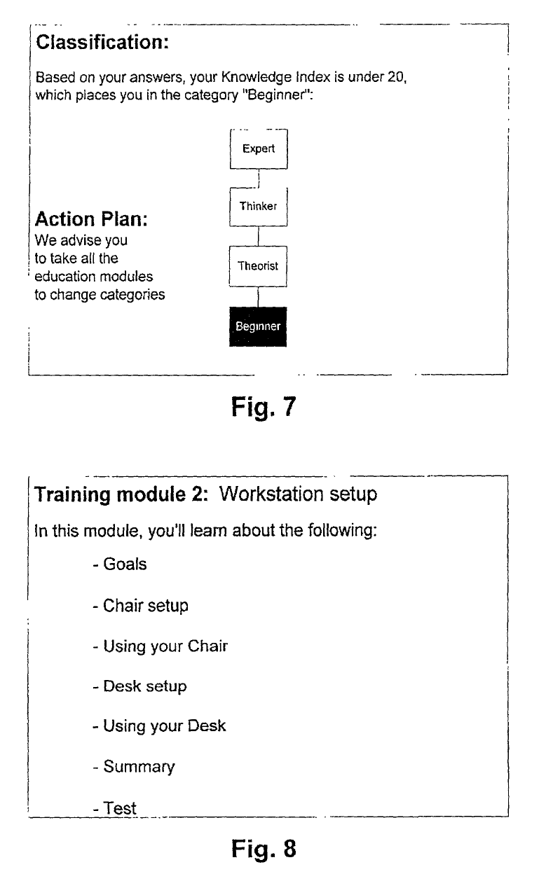

FIG. 7 shows a user interface screen for presenting a user classification and an action plan for the user,

FIG. 8 shows a user interface screen for workstation setup,

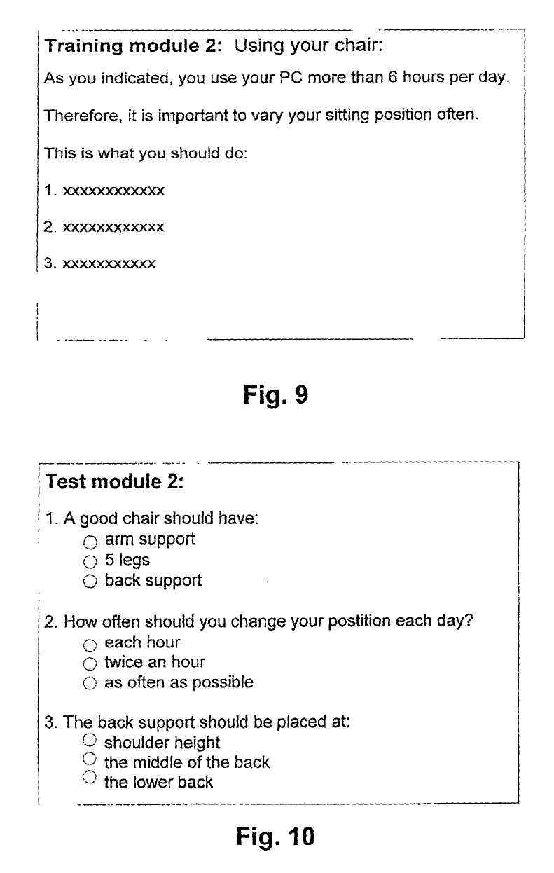

FIG. 9 shows a user interface screen for a training module,

FIG. 10 shows a user interface screen for a test module,

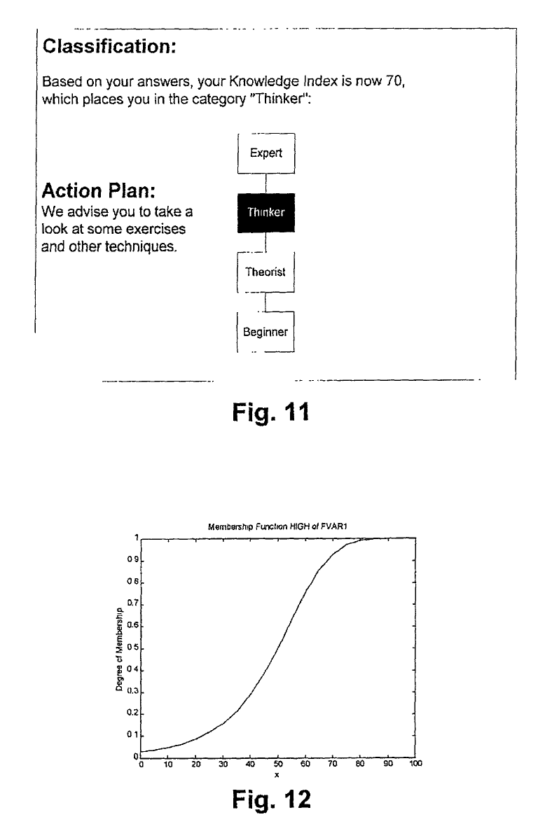

FIG. 11 shows a user interface screen for presenting a user classification and an action plan for the user, after a number of test and training modules have been performed,

FIG. 12 shows a membership function for the fuzzy variables,

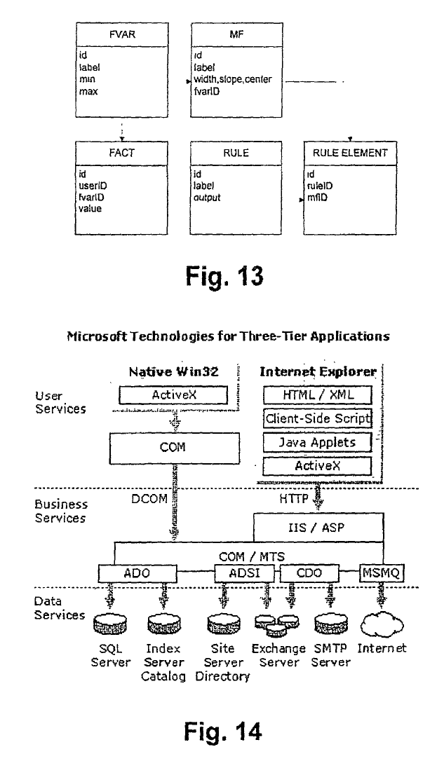

FIG. 13 shows how to represent fuzzy variables (FVAR), membership functions (MF), rules and facts in a relational database, and

FIGS. 14-18 shows specific implementation architecture for a system according to the invention.

As indicated herein, the method of the invention may be implemented using a suitable computer system. An example of a suitable system is the following:

1. Server

A computer functioning as a server and containing the central databases and programs to control training and evaluation. A typical server contains a suitable CPU such as an Intel Pentium processor running the Microsoft NT Server operating system with Microsoft Internet Information Server software and SQL Server to control the database. These programs are quite common and are presently considered de-facto industry standards, but it is evident that there will be other software systems that may be used, including systems pertaining to environments based on Linux, Unix, Macintosh or other suitable operating systems. The database used by the computer system may reside on hard discs In the server, or it or part of it may reside elsewhere in the network, either as one physical set of files or as a database integrating several co-operating sets of files residing in various physical places. What is important is that the functionality of a database is available to the computer system. The database may be of any suitable type, e.g., a relational database, a configuration database, etc.

2. Network

The server is suitably connected to a network of users, and in the preferred embodiment, this network is the Internet using TCP/IP communication protocols. This network is compatible on a global scale in many countries, but other networks could be used, for example within a single company or over a cable television or wireless mobile phone networks. The communications protocol used by the server must be compatible with the protocols used by the clients and enable two-way communication.

3. Client

The user's computer (“client”) runs programs to display the training and information and collect data and instructions from the user and send it to the server. In a presently preferred embodiment, a typical client computer uses the Microsoft Windows operating system with an Internet browser program such as Microsoft Internet Explorer with a Macromedia Flash plug-in. Other available operating systems, such as Apple OS, or other available browsers, such as Netscape Navigator, can also be used. The Flash plug-in enables viewing of complex images and animation which enhances the training effect, but this is not essential to implement the basic method.

The user's computer is typically an “IBM-compatible PC” with an Intel Pentium processor or a similar unit or a further development thereof, at least 32 MB of RAM, graphics card and modem or network card to connect to the Internet or another network used by the computer system. A display and speakers are typically necessary to communicate information to the user. Other machine configurations (e.g., Apple Macintosh) are of course possible as long as they can run a browser program as described above. Non-PC-based and non-PC-like implementations are also possible. In accordance with the recent trend for miniaturizing effective computers and/or combining them with other types of instruments such as mobile phones, e.g. of the WAP type, and/or personal digital assistants of the Palm Pilot type, the user's computer may, of course, also be such a type or, e.g., a computer integrated in or attached to virtual reality equipment. A television set integrating the necessary computer functionality may also suitably be used,

Devices attached to the user's computer can collect data and send it to the server. These are typically a keyboard and mouse, but could also, as indicated above, be devices which measure data from physical sources, like a thermometer, light sensor, desk-position indicator, etc. These devices may even be connected to a user's body, for example a heart-rate monitor.

The essential requirements for the invention are that the computer devices and, where applicable, their peripherals, can display personalized information from the server and collect data from the user, e.g., through a keyboard, mouse or other input device.

### EXAMPLE 1

1. First, a company administrator (or a training service provider) determines which reference measures are relevant to the organization and which will determine successful completion of the training. Each reference measure comprises characteristics which can be measured — see FIG. 2.

2. Then, at a later time, an employee logs on to the system with their personal user name, organization identification and password. This ensures that any changes in behavior, knowledge, etc. can be identified with the individual and their organization — see FIG. 3.

3. User is greeted and asked questions (i.e. Series A) related to their behavior, knowledge, etc. defined as Parameters P1 — see FIG. 4.

4. Answers to the questions (i.e. Parameters P1) are stored in a database and are considered the starting condition of the individual — see FIG. 5.

5. After answering questions, the system combines the answers using fuzzy logic, creates an index and presents a preliminary personal evaluation — see FIG. 6.

6. Based on their answers above, the user is classified in an index which the organization has identified as relevant. Based on this classification, the user is presented with an Action Plan suggesting what to do next — see FIG. 7.

7. The Action Plan may recommend a training module, (i.e. another Series A) which gives information to the user and may also collect information from the user (further parameters P1, P2 P3) — see FIG. 8.

8. Information and training is presented to the user and is personalized based on previously entered data — see FIG. 9.

9. At the end of a training module, the user is tested in their knowledge of the topic and the resulting answers are also stored in the database — see FIG. 10.

10. The data collected during the training and the testing is compared to the previously collected Parameters P1, and the user is then re-classified. As a result of the classification, they will see a revised action plan — see FIG. 11. The user continues to follow the Action Plan until the desired conditions are met (as defined by the organization in Step 1, above).

### EXAMPLE 2

Using Fuzzy Logic to Calculate Index Values

As discussed herein, index values are a way to represent complex information in a single value/number. Based on facts about an individual, fuzzy logic and rules may be used to calculate index values. By using fuzzy logic, it becomes possible to describe the relationships between facts and indexes in a natural language.

Theory

Facts about an individual are stored in a database. Each type of fact (ex. age, height, weight etc.) is then related to a fuzzy variable (FVAR). A fuzzy variable contains a number of fuzzy sets, A membership function (MF) defines the degree to which a variable is contained in a fuzzy set.

Illustration 1:

The fuzzy variable (fact type) “age” has two related sets: low and high. For a given value of “age”, the membership function of “low” defines the degree to which the value of “age” is “low”.

Fuzzy rules can be used to combine a given set of facts into an index. An index rule consists of a premise part, and a consequence part. The overall value of the premise part determines the value of the consequence part. For a given set of facts X, the index rule can be written as:

INDEX1:=(FVAR1(X)=LOW)*(FVAR2(X)=HIGH)*(FVAR3(X)=LOW).

Illustration 2:

The following example is taken from an ergonomic education application. Based on four facts about the behavior of an individual, it uses a fuzzy rule to calculate a behavior index:

Fuzzy Variables:

FVAR1: does the individual take any precautions to prevent injuries?

FVAR2: how many hours does the individual sit down during a normal work day?

FVAR3: how many hours does the individual use his/her computer during the day?

FVAR4: how many breaks does the individual take during a day?

Calculation of Behavior Index:

INDEX=

(FVAR1(X)=HIGH)*(FVAR2(X)=LOW)*

(FVAR3(X)=LOW)*(FVAR4(X)=HIGH)

If, for example, the individual answered 45 on a scale from 0 to 100 to the question related to FVAR1(“do you take any precautions. . . ”), the value of (FVAR1(45)=HIGH) represents the value of the membership function HIGH of variable FVAR1. Membership functions are defined using the formula μ(x,a,b,c)=1/(1+(abs(x−c)/a) [symbol] (2* b)), where a, b, and c are parameters that define the shape of the membership function, and x is the value of the fuzzy variable — see FIG. 12.

For x=45, and (a,b,c)=(50,2.5,100), the degree of membership becomes μ=0.38. Similarly, the values of FVAR2/LOW, FVAR3/LOW and FVAR4/HIGH are found, and the index is calculated as:

INDEX=

(FVAR1(X)=HIGH)*(FVAR2(X)=LOW)*

(FVAR3(X)=LOW)*(FVAR4(X)=HIGH)=0.38*0.7*0.4*0.6=0.06

Data Representation

The FIG. 13 shows how to represent fuzzy variables (FVAR), membership functions (MF), rules and facts in a relational database.

Implementation

When implemented on a web-server, the index calculation is best implemented as a compiled server component, ex. as a COM component on an MS Internet Information Server.

The calculations are based on a single query to the database (SOL):

SELECT DISTINCT T_Rule.rutelD, T_Rule.tip|D, T_MF.width, T_MF.slope, T_MF.center, T_RuleElement.[not], T_Fvar.min, T_Fvar.max, T_Fact.answer, T_Tips.label

FROM T_Tips INNER JOIN (T_Rule INNER JOIN (((T_Fvar INNER JOIN T_Fact ON T_Fvar.fvar|D=T_Fact.fvar|D)INNER JOIN T_MF ON T_Fvar.fvarlD=T_MF.fvar|D)

INNER JOIN T_RuleElement ON T_MF.mf|D=T_RuleElement.mf_D) ON T_Rule.rule|D=T_RuleElement.rule|D) ON T_Tips.tip|D=T_Rule.tip|D

WHERE BY T_Fact.userID)=“& user|D &”)

ORDER BY T_Rule.rule|D

The following code shows how to implement the calculations in MS Visual Basic:

Option Explicit

Option Base 0

Private Function evalMF(a, b, c, x As Double) As Double evalMF=1/ (1+Abs((x−c) / a) [symbol] (2 * b))

End Function

Public Function getTips(connectionString As String, userID As Long) As Variant

Dim db As New ADODB.Connection

Dim rs As New ADODB.Recordset

Dim sqlStatement As String

Dim rows As Integer

Dim columns As Integer

Dim i As Integer

Dim j As Integer

Dim ruleNumber As Integer

Dim a As Double

Dim b As Double

Dim c As Double

Dim x As Double

Dim temp As Double

Dim temp2 As Integer

Dim temp3 As String

Dim data, outputs

Dim test As String

Dim noo As Integer

Make connection

db.Open connectionstring

rs.ActiveConnection=db

rs.CursorType=adOpenStatic

sqistatement=“SELECT DISTINCT T_Rule.ruleID, T_Rule.tipID, T_MF.width, T_MF.slope, T_MF.center, T_RuleElement.[not], T_Fvdr.min, T_Fvar max, T_ract.answer, T_Tips.label” & _{—}

“FROM T_Tips INNER JOIN (T_Rule INNER JOIN (((T_Fvar INNER JOIN T_Fact ON T_Fvar.fvarID=T_Fact.fvarID) INNER JOIN T_MF ON T_Fvar.EvarID=T_MF.fvarID) INNER JOIN T_RuleElement ON T_MF.mfID=T_RuleElement.mfID) ON T_Rule.ruleID=T_RuleElement.ruleID) ON T_Tips.tipID=T_Rule.tipID” & _{—}

“Where (((T_Rule.ruleTypeID)=1) And ((T_Fact.userID)=” & userID & “))”& _{—}

“ORDER BY T_Rule.ruleID”

rs.Open sqlStatement

columns=rs.Fields.Count

rows=rs.RecordCount

ReDim data(rows, columns+1)

For i=0 To rows−1

For j=0 To columns−1

data(i, j)=rs.Fields(j)

Next

rs.MoveNext

10 Next

rs.Close

db.Close

i=

noo=0

ruleNumber=−1

While i<rows

If ruleNumber<>data(i, 0) Then

ruleNumber=data(i, 0)

temp=1

noo=noo+1

End If

a=data(i, 2)

b=data(i, 3)

c=data(i, 4)

x=data(i, 8)

If x<data(i, 6) Then

x=data(i, 6)

End If

30 If x>data(i, 7) Then

x=data(i, 7)

End If

x=evalMF(a, b, c, x)

If data(i, 5)=“Sand” Then

x=1−x

End If

temp=temp * x

data(i, 10) temp

i=i+1

Wend

ReDim outputs(noo, 3)

noo=0

For i 0 To rows−1

If i<(rows−1) Then

If data(i, 0)<>data(i+1, 0) Then

outputs(noo, 0)=data(i, 1)

outputs(noo, 1)=data(i, 10)

outputs(noo, 2)=data(i, 9)

noo=noo+1

End If

Else

outputs(noo, 0)=data(i, 1)

outputs(noo, 1)=data(i, 10)

outputs(noo, 2)=data(i, 9)

noo=noo+1

End If

Next

'Bubble sort

For i=0 To noo−2

For j=0 To noo−2−i

If outputs(j, 1)<outputs(j+1, 1) Then

temp2=outputs(j, 0)

temp=outputs(j, 1)

temp3=outputs(j, 2)

outputs(j, 0)=outputs(j+1, 0)

outputs(j, 1)=outputs(j+1, 1)

outputs(j, 2)=outputs(j+1, 2)

outputs(j+1, 0)=temp2

outputs(j+1, 1)=temp

outputs(j+1, 2)=temp3

End If

Next

Next

getTips=outputs

End Function

General Technology

The described system may preferably be based on regular Microsoft technology:

Windows NT operative system

SQL Server 7.0 relational database

Internet Information Server — web server

Active Server Pages 2.0

ActiveX DLL (COM)

Visual Basic 6.0

The overall system architecture is disclosed in FIG. 14.

The system runs partly as a typical web application:

The client

Web browser with access to the Internet/World Wide Web via TCP/IP.

Server

Web server which through a server-side scripting language (ASP) generates HTML based on requests transmitted from the client.

Database server

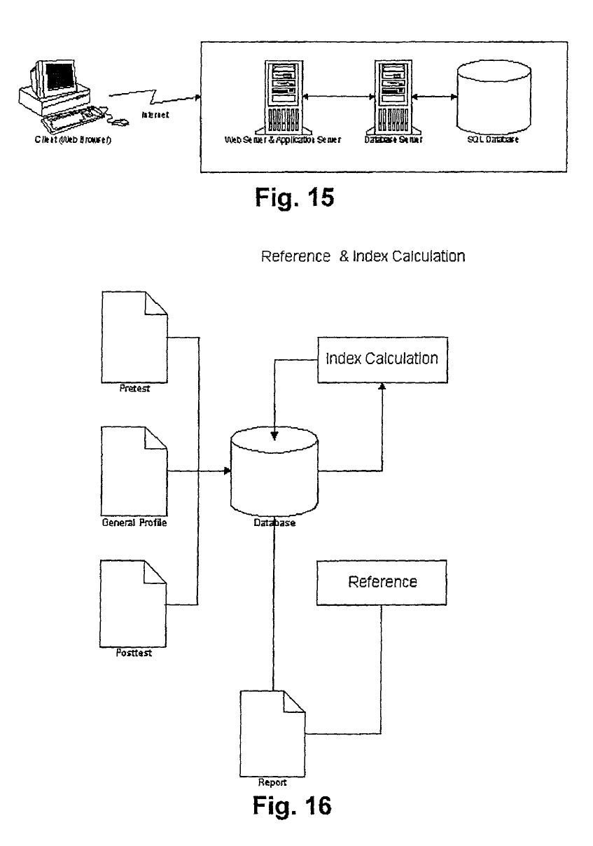

See FIG. 15.

Index and Reference Values

The index measurements are based on input from the system (and in time, also from local sensors and programs of computers connected to the system — e.g. the Ergosensor to be described in details below). The original inputs are stored in a database, and at specific states in the system a vector of corresponding index values are calculated. We use two methods for calculating the index:

Weighted average

Sugeno Inference System (fuzzy logic)

Organizations can define their reference values in relation the indexes, and a report is presented to the administrators of the organization, indicating the values of indexes of users belonging to the organization in relation the reference — see FIG. 16.

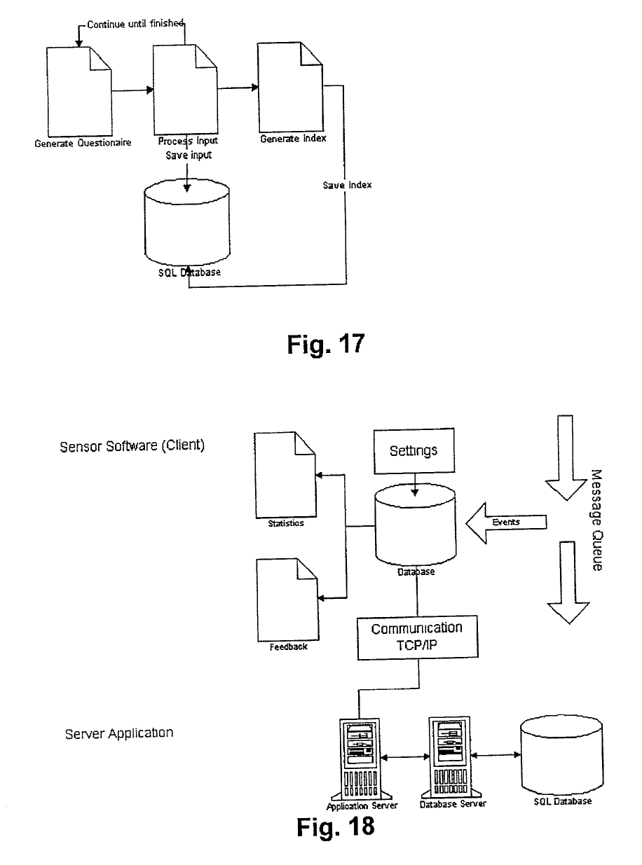

Data collection is done by using a combination of HTML and Active Server Pages (ASP). ASP scripts on the web server generate HTML representing questionnaires. These questionnaires are submitted back to the web server for processing. When a collection of questionnaires have been answered by a user, the corresponding vector of indexes is calculated and saved in the database — see FIG. 17.

Ergosensor

Ergosensor is a Windows application which measure a users behavior at a computer of the user. As an example the number of key strokes on the keyboard, the number of mouse clicks and periods wherein the user is not actively working with the computer, will be measured or determined. Ergosensor is thus a device of the individuals computer, adapted to measure and report electrical signal representative of the behavior of the user of the computer.

Ergosensor is using the Message Queue e.g. of the Windows™ operating system in order to register the users use of a device such as a mouse or the keyboard. The measured data is stored locally in a database of the computer or eventually in a database of the computer system as such.

Ergosensor uses the registered events to give the user feedback e.g. in relation to the use of the mouse, suggestions for brakes or suggestions to do certain exercises.

Ergosensor is adapted to, at a certain frequency to upload the registered events to the computer system, e.g. over the Internet. At the same time, the Ergosensor will be updated with the latest updates from the computer system. As an example, the Ergosensor may be updated with a new training program which may be suggested to the user.

The communication between the Ergosensor and the computer system could take place over the Internet by use of TCP/IP — see FIG. 18.

Knowledge Engineering

The below described method is a manual method. However, the method may just as well be implemented in the system as a fully automatic method for deriving the indexes described.

Knowledge Engineering means using Neuro-Fuzzy and determining in order to improve the rules already existing in the expert system, the following steps may be suggested:

Gathering data material, e.g. by sensing the individuals use of the computer or by means of questionnaires.

Splitting the data material into training data and control data.

Identification of required output - e.g. an index for the behavior of the individual.

Establish profiles and questionnaires for experts.

Use simulated Annealing or clustering for selection of relevant input.

Teach the network.

Implement the new rules in the existing expert system.

Relevant Literature:

Neuro-Fuzzy and Soft Computing: A Computational Approach to Learning and Machine Intelligence by Jyh-Shing Roger Jang, Chuen-Tsai Sun (Contributor), Eiji Mizutani

1. A method for interactively monitoring and optionally changing the behavior state(s) and/or attitude state(s) and/or educational state(s) of an individual, comprising
storing, in a database of a computer system,
a reference measure with respect to the behavior state(s) and/or attitude state(s) and/or educational state(s), the reference measure quantifying characteristics relating to the same state(s),
subjecting the individual to a series A of information and/or training routines and/or questions relevant to the said state(s), and recording at least one set of parameters P1 established as a result of the series A and related to the individual or activities of the individual and indicative of the said state(s), and storing the result of the recording in a database of the computer system,
processing the set(s) of parameters P1 to provide at least one index representing the status of the individual with respect to the said state(s),
comparing the at least one index with the reference measure,
and, based on the result of the comparison,
a) classifying the individual, and/or
b) subjecting the individual to further questions and/or information and/or training routines of either series a or another series:

2. A method according to claim 1, wherein the reference measure comprises quantification values corresponding to a desired end condition of the individual.

3. A method according to claim 1, wherein the individual is an individual related to an organization, and the reference measure is a reference measure selected or at least partly defined by that organization.

4. A method according to claim 1 , which further comprises storing in a database of the computer system
characteristics relating to a starting condition of the individual with respect to the behavior and/or attitude and/or educational state(s), and
processing the characteristics relating to the starting conditions together with the processing of the set(s) of parameters P1,
and/or comparing the set(s) of parameters P1 and/or the index with the starting condition and/or the reference measure and/or the desired end condition, and, based on the result of the comparison,
a) classifying the individual, and/or
b) subjecting the individual to further questions and/or information and/or training routines of either series A or another series.

5. A method according to claim 1, in which one or more sets of parameters P2 relating to a physical state of the individual is/are included in the processing to provide the at least one index.

6. A method according to claim 1, wherein one or more sets of parameters P3 relating to an environment of the individual is/are included in the processing to provide the at least one index.

7. A method according to claim 5, wherein the one or more sets of parameters P2 and/or P3 has/have been pre-stored in the computer system.

8. A method according to claim 5, wherein the one or more sets of parameters P2 and/or P3 is/are recorded as a result of subjecting the individual to the series A.

9. A method according to claim 5 , wherein the one or more sets of parameters P1 and/or P2 and/or P3 is/are recorded by means of one or more measuring devices.

10. A method according to claim 9, wherein the one or more measuring devices is/are measuring devices capable of directly or indirectly communicating with the computer system.

11. A method according to claim 9, wherein the one or more sets of parameters P1 and/or P2 and/or P3 is/are recorded by monitoring the individual's use or configuration of a device.

12. A method according to claim 11, wherein the device is selected from the group consisting of telephones, including mobile telephones; personal digital assistants (PDA); fax machines; scanners; dictating machines, cameras, including still cameras and video cameras, microphones; furniture; tools, instruments, production machines, conveyors, sorters, vehicles, medical devices, prosthetics, care utensils, such as wheelchairs and hoists.

13. A method according to claim 11, wherein the device is a computer or a computer peripheral such as an input device, e.g., a mouse or a keyboard.

14. A method according to claim 11, wherein the recording is performed at least in part by the individual inputting parameter-relevant data into the computer system.

15. A method according to claim 11 wherein the recording is performed by the device directly or indirectly communicating with the computer system.

16. A method according to claim 1 wherein the processing of the parameters to provide the at least one index is based on functions using a combination of static rules and rules derived from previous use of the method.

17. A method according to claim 16, wherein the functions comprise functions selected from the group consisting of calculation, statistical calculation, stochastic simulation, fuzzy logic rules and adaptive networks, such as neural networks, so as to establish, for a given number of parameters each having a predetermined result space, the result space for combinations of the parameters.

18. A method according to claim 17, wherein the determination of the result space of at least some of the parameters is performed based on consolidated data from a number of individuals.

19. A method according to claim 1 wherein the reference measure is adjusted periodically to take into account an increased quality in prediction based on an increased number of relevant parameter data which have been gathered.

20. A method according to claim 2 , wherein the individual is being informed about its progress relative to the desired end status of the individual expressed by the reference measure.

21. A method according to claim 20, wherein the individual is being alerted if the set of parameters P1 and/or P2 and/or P3 results in an index which indicates a lower standard than expressed by the reference measure.

22. A method according to claim 21, wherein the alerting is given in form of an interruption of a job routine related to the alerting given.

23. A method according to claim 2, wherein the behavior and/or attitude state relevant to the organization is ergonomically related behavior, the educational state refers to the knowledge of the individual with respect to ergonomics, and the environment to which the organization subjects the individual refers to ergonomically relevant conditions of the individual's working surroundings.

24. A method according to claim 2, wherein the behavior and/or attitude state relevant to the organization refers to environmentally reasonable conduct of the individual and wherein the educational state of the individual refers to the knowledge of the individual with respect to the environmental issues in question.

25. A method according to claim 2, wherein the behavior and/or attitude state relevant to the organization refers to economically reasonable conduct of the individual and wherein the educational state of the individual refers to the knowledge of the individual with respect to the economical issues in question.

26. A method according to claim 2, wherein the behavior and/or attitude state relevant to the organization refers to socially reasonable conduct of the individual and wherein the educational state of the individual refer to the knowledge of the individual with respect to the social issues in question.

27. A method according to claim 23, wherein the index generated is one or more of the following:
health index
attitude index
knowledge index
behavior index
performance index
physical environment index
risk index
the risk index being the probability of future changes of the other indices.

28. A method according to claim 1 wherein the index is represented graphically by means of the interface in which
the index is represented as a function of the reference measure and/or
the index is represented as a function of one of the sets of parameters P1 and P2 and P3.

29. A method according to claim 1 wherein at least one of the indexes or the parameters P1, P2 or P3 is further processed by processing means using a simulation algorithm for forecasting data relevant to the organization or the individual.

30. A method according to claims 1 wherein the computer system communicates through a network with a computer at the individual site and optionally with at least one more computer.

31. A method according to claim 1 wherein one or more sets of data each containing at least one of the following types of data
reference measure,
series A,
set of parameters P1,
set of parameters P2,
set of parameters P3,
at least one index and/or
forecast data relevant to the organization or the individual,
is/are used for defining groups of one or more individuals, and data for individual groups are compared or analyzed.

32. A method according to claim 31, wherein the data for individual groups which are compared are data which are not identical to the sets of data according to which the groups were defined.

33. A method according to claim 32, wherein the data which are compared are data pertaining to the types of data defined in claim 31.

34. A method according to claim 31 , wherein the development over time of data values for individuals within individual groups is compared or analyzed.

35. A method according to claim 1 , wherein data selected from the group consisting of
reference measure,
series A,
set of parameters P1,
set of parameters P2,
set of parameters P3,
at least one index and/or
forecast data relevant to the organization or the individual,
is used or processed to obtain methodical and/or statistical surveillance/observation or analysis of a group of one or more individuals or a group of one or more organizations.

36. A method according to claim 35, wherein the data is accumulated over a period of time, and the accumulated data is used or processed.

37. A method according to claim I , wherein data selected from the group consisting of
reference measure,
series A,
set of parameters P1,
set of parameters P2,
set of parameters P3,
at least one index and/or
forecast data relevant to the organization or the individual
is defined for a group of one or more individuals and is compared to the same data of another group of one or more individuals.

38. A method according to claim 1 , wherein at least one of the following types of data:
reference measure,
series A,
set of parameters P1,
set of parameters P2,
set of parameters P3,
at least one index and/or
forecast data relevant to the organization or the individual,
is compared between one individual and at least one other individual of the organization or of another organization.

40. A method according to claim 1 wherein at least one of the following types of data:
reference measure,
series A,
set of parameters P1,
set of parameters P2,
set of parameters P3,
at least one index and/or
forecast data relevant to the organization or the individual,
is compared between the organization and at least one other organization.

41. A method according to claim 1 , wherein the at least one of the following types of data:
reference measure,
series A,
set of parameters P1,
set of parameters P2,
set of parameters P3,
at least one index and/or
forecast data relevant to the organization or the individual,
is compared between the individual and at least one organization.

42. A computer system for interactively monitoring and optionally changing the behavior state(s) and/or attitude state(s) and/or educational state(s) of an individual, said computer system having first processing means, input means for user provided input, output means and first storage means having stored therein a first computer program said processing means being adapted, in response to commands from said computer program, to:
store a reference measure with respect to the behavior state(s) and/or attitude state(s) and/or educational state(s), in a database of the computer system,
subject the individual to a series A of information and/or training routines and/or questions relevant to the said state(s), and recording at least one set of parameters P1 established as a result of the series A and related to the individual or activities of the individual and indicative of the said state(s), and to store the result of the recording in a database of the computer system,
process the set(s) of parameters P1 to provide at least one index representing the status of the individual with respect to the said state(s),
compare the at least one index with the reference measure, and, based on the result of the comparison, to classify the individual, and/or subject the individual to further questions and/or information and/or training routines of either series A or another series.

43. A computer system according to claim 42, wherein the processing means is adapted for, in response to commands from said computer program, to interactively monitor and optionally change the behavior state(s) and/or attitude state(s) and/or educational state(s) of an individual over a computer being used by the individual, the computer being connected to the computer system and cooperating herewith.

44. A computer system according to claim 43, wherein the cooperation between the computer system and the computer is independent on the operating system of the computer system respectively the operating system of the computer.

45. A computer system according to claim 43 , wherein the computer comprises means for user interaction, second processing means and second storage means having stored therein a second computer program, said second processing means being adapted, in response to commands from the second computer program, to monitor a users behavior with respect to the users use of the computer, the monitored behavior being stored in a file and communicated to the computer system.

46. A computer system according to claim 45, wherein the second processing means is adapted to automatically read and execute instructions from the second computer program upon activation of the computer.

47. A computer system according to claim 42, wherein the first processing means is adapted to compare the users behavior with reference behavior data stored within the first storage means.

48. A computer system according to claim 42, wherein the second processing means is adapted to compare the users behavior with reference behavior data stored within the first storage means or with reference behavior data stored within the second storage means.

49. A computer system according to claim 42, wherein computer is operated by the Windows™ operating system and wherein the second processing means is adapted, in response to commands from the second computer program, to monitor the behavior of the user by monitoring a Windows™ messaging cue of the Windows™ operating system.

50. A computer system according to claim 42, wherein the behavior of the user is monitored by the first processing means by monitoring a Windows™ messaging cue of a Windows™ operating system of the computer, the Windows™ messaging cue being provided to the computer system by the computer.

51. A computer system according to claim 42, wherein second processing means is adapted to provide at least one index representing the behavior of the user.

52. A computer system according to claim 51, wherein the second processing means is adapted, in response to commands from the second program, to compare the index with a reference index stored in the second storing means or in the first storing means.

53. A computer system according to claim 51, wherein the first processing means is adapted, in response to commands from the first program, to compare the index with a reference index stored in the second storing means or in the first storing means.

54. A computer system according to claim 52, wherein the second processing means is adapted, in response to commands from the second computer program, to generate user instructions, the user instructions being generated based on the comparison of the index with a reference index and the user instructions being provided to the user via the means for user interaction.

55. A computer system according to claim 42, further comprising sensor means for determining a first electrical signal indicative of a physiologic factor of the individual and for transferring the first electrical signal to the second processing means.

56. A computer system according to claim 42, further comprising sensor means for determining a second electric signal indicative of ergonomically relevant conditions of the individual's working surroundings and for transferring the second electrical signal to the second processing means.

57. A computer system according to claim 55, wherein the sensor means for determining the first electrical signal or the sensor means for determining the second electrical signal is comprised in a computer peripheral device.

58. A computer system according to claim 42, wherein a user profile is stored in the first storing means or in the second storing means and wherein the second program is configured by the first processing means and the second processing means, the configuration being based on the user profile.

59. A computer system according to claim 58, wherein the user profile is generated by the first processing means and stored in the first storage means or in the second storage means, the user profile being generated based on a pre-test program with a questionnaire for the user.

60. A computer system according to claim 42, wherein the user instructions and/or the index is presented graphically for the user by means of an ActiveX or a JAVA application executed on the computer and provided with data from the first storage means.
